(19) United States
(12) Patent Application Publication
(10) Pub. No.: US 2011/0169450 A1
(43) Pub. Date: Jul. 14, 2011

(54) BATTERY CONTROL APPARATUS

(76) Inventors: Coy A. Hudnall, Knoxville, TN (US); William E. Bowman, Miami, FL (US); Kevin J. Bennett, Corryton, TN (US)

(21) Appl. No.: 12/836,360

(22) Filed: Jul. 14, 2010

Related U.S. Application Data
(60) Provisional application No. 61/225,395, filed on Jul. 14, 2009.

(51) Int. Cl. H02J 7/04

(52) U.S. Cl. 320/114

(57) ABSTRACT

A battery includes an on-board microprocessor-controlled MOSFET-switched cell monitoring and protection system which provides over-charge protection, low-voltage protection, thermal-runaway protection and cell balancing. The output voltage of the battery is fully regulated and user adjustable. Internal switching provides for switching the battery on or off from a control interface on the battery housing or from a remotely located switch. The battery preferably incorporates lithium iron phosphate (LiFePO₄) power cells, although the monitoring and protection circuitry is also applicable to lithium ion and other cell chemistries. The battery includes a charging input connection separate from the voltage output connection which allows for charging the battery at a voltage considerably higher than the output voltage.

### CROSS REFERENCE TO RELATED APPLICATION

This application claims priority to U.S. Provisional Patent Application Ser. No. 61/225,395 entitled “Battery Control System” to Coy A. Hudnall et al. having a filing date of Jul. 14, 2009, the contents of which is incorporated herein by reference in its entirety.

### FIELD

This disclosure relates to the field of electrical batteries. More particularly, this disclosure relates to an apparatus for controlling and monitoring the operation of a battery.

### BACKGROUND

In high-performance battery applications, lithium ion batteries and lithium iron phosphate (LiFePO₄) batteries are favored for their very high power-to-size ratio (specific energy), rapid charge and discharge rates, and light weight. However, if operated improperly, such batteries are prone to thermal runaway. This can occur when one cell within a battery fails and the other cells begin to discharge through the failed cell. The failed cell, which acts as a resistor to the discharge current, can then overheat and cause a fire or explosion.

In automotive applications, it is advantageous for a vehicle's electrical system to maintain a near constant voltage. In most passenger vehicles, an alternator is used for this purpose. However, in racing applications where it is desirable to eliminate all unnecessary weight, alternators are disfavored and other means are needed to regulate vehicle battery voltage. Thus, no-alternator racers desire a battery that will maintain a near constant voltage throughout an entire pass of a race.

What is needed, therefore, is a high-performance, light-weight battery having regulated output voltage and self-monitoring diagnostic circuitry to prevent thermal runaway. It is also desirable to be able to set the output voltage level, and completely disable the battery when not in use.

### SUMMARY

The above and other needs are met by a portable battery including a plurality of power cells, a voltage regulation circuit connected to the plurality of power cells, and an output voltage adjustment circuit connected to the voltage regulation circuit, and a housing for at least partially sheltering at least some of the other parts of the portable battery. The battery has an on-board microprocessor-controlled MOSFET-switched cell monitoring and protection system. The system provides over-charge protection, low-voltage protection, thermal-runaway protection and cell balancing. The output voltage of the battery is fully regulated and user adjustable. Internal switching provides for switching the battery on or off from a control interface on the battery housing or from a remotely located switch. Although preferred embodiments of the battery preferably incorporate lithium iron phosphate (LiFePO₄) power cells, the monitoring and protection circuitry is also applicable to lithium ion and other cell chemistries. Embodiments of the battery include a charging input connection that is separate from the voltage output connection which allows for charging the battery at a voltage considerably higher than the output voltage.

In a preferred embodiment, the battery includes a portable battery housing in which are disposed a plurality of power cells for generating a cell voltage. Also disposed within the housing is a voltage regulation circuit connected to the power cells. The voltage regulation circuit maintains a substantially constant output voltage as the cell voltage changes due to discharge over time. An output voltage adjustment circuit is disposed within the housing and connected to the voltage regulation circuit. The output voltage adjustment circuit is controllable by a user of the battery to adjust the output voltage to a user-selected level. In some embodiments, the power cells further include a plurality of legs connected in parallel wherein each leg includes a plurality of cells connected in series. These embodiments may include a charging circuit having a switching network operable to individually connect or disconnect each of the legs to or from the charging input connection. In a most preferred embodiment, the switching network of the charging circuit is controlled by a microprocessor disposed within the battery housing.

In another preferred embodiment, the portable battery further includes a user input device to modify an output voltage to a user-selected level. This embodiment further includes a polling circuit including a second switching network that is operable to individually connect or disconnect each of the legs to or from a voltage output connection and the charging input connection. This embodiment also includes a voltmeter disposed within the battery housing and connected to each of the legs of the power cells. The voltmeter is operable to measure an output voltage on a particular leg during a time period when such leg is disconnected from both the voltage output connection and the charging input connection. When the switching network of the polling circuit disconnects a leg of the power cells from the voltage output connection and the charging input connection, the voltmeter measures the output voltage on the disconnected leg.

In a most preferred embodiment, the switching network of the polling circuit is controlled by control circuitry, such as a microprocessor, which measures the leg voltage sensed by the voltmeter. If the leg voltage falls above or below a preset threshold level which may indicate a fault in the leg, the microprocessor is operable to control the polling circuit to isolate the faulty leg from the voltage output connection and the charging input connection to prevent damage to the other legs of the power cells.

In multiple-cell batteries it is important that the cells be balanced and that any cells that are shorted or otherwise deviant be identified. In the preferred embodiment, the battery includes a plurality of heat sensors connected to the control circuitry and located adjacent or within one or more zones located within the battery, microprocessor takes reference measurements of the open circuit voltage (OCV) of each series leg. Alternatively, the microprocessor may take reference measurements of the open circuit voltage of each leg periodically. The OCV of each series leg is compared to the other series legs, and the control circuitry monitors the heat sensors to determine whether the one or more zones exhibit a temperature outside the predefined range. A first heat sensor is located adjacent a first leg for sensing the temperature of a first zone, a second heat sensor is located adjacent a second leg for sensing the temperature of a second zone, and an N^{th} heat sensor is located adjacent an N^{th} leg for sensing the temperature of an N^{th} zone, wherein the control circuitry is operable to disable one or more legs in the event the sensed temperature or temperatures for the one or more legs is outside the predefined range. Additionally, for any leg that deviates from the group's average and/or maximum by a predetermined amount, the microprocessor may transmit a deviation signal identifying the one or more deviating legs to a feedback system.

In one version, the feedback system may include an indicator light, a display screen, or automated cutoff circuitry. Any leg that deviates from the group's average and/or maximum by a predetermined amount is tagged as an outlier. An outlier may be switched out of the configuration if predetermined parameters determine it to be bad.

In another version, the feedback system may include a circuit configured for automatically disabling one or more legs in response to a deviation signal identifying one or more legs having an output voltage that is outside the predefined voltage range.

In yet another embodiment, the portable battery includes a display device connected to the microprocessor for displaying information indicating the status of the portable battery or one or more sub-parts of the portable battery.

In yet another embodiment, a method of maintaining optimal performance for a portable battery including a plurality of legs connected in parallel is contemplated. The method includes the steps of receiving one or more sensor signals from one or more sensors associated with one or more of the legs, wherein the sensor signals are indicative of a characteristic of one or more the legs; determining based on the sensor signals whether the sensed characteristic is outside a predefined range; and disabling a leg if it is determined that the characteristic sensed for that leg is outside the predefined range. In a first version, the characteristic is temperature. In a second version, the characteristic is open circuit voltage

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 depicts a somewhat schematic functional block diagram of a system for controlling and monitoring the operation of a battery according to an embodiment of the invention;

FIG. 2 depicts a somewhat schematic battery voltage regulation circuit according to an embodiment of the invention;

FIG. 3 depicts a somewhat schematic battery charging circuit according to an embodiment of the invention;

FIG. 4 depicts a somewhat schematic battery polling circuit according to an embodiment of the invention;

FIGS. 5-7 depict schematic diagrams of a system for controlling and monitoring the operation of a battery according to an embodiment of the invention;

FIG. 8 depicts a physical configuration of a battery according to an embodiment of the invention; and

FIG. 9 depicts a somewhat schematic functional block diagram of a system for controlling and monitoring the operation of a battery according to an embodiment of the invention.

### DETAILED DESCRIPTION

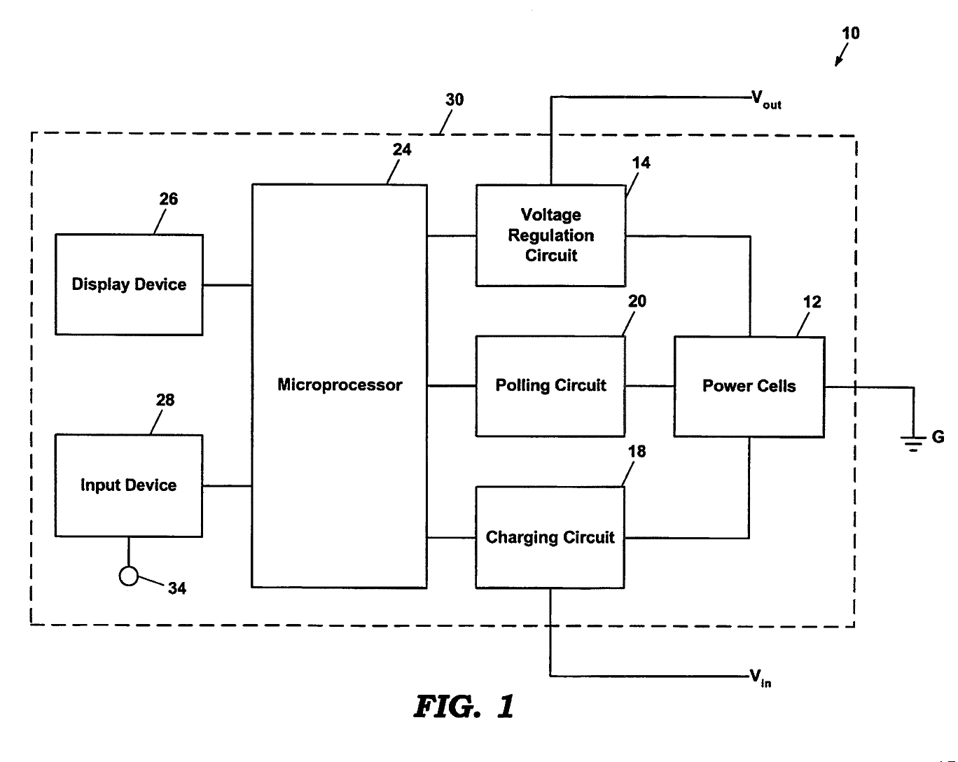

FIG. 1 depicts a battery 10 having circuitry for monitoring and controlling the operation of power cells within the battery 10. In a preferred embodiment, the battery 10 includes power cells 12, a voltage regulation circuit 14, a polling circuit 20, and a charging circuit 18, all of which are controlled by a microprocessor 24. These components are contained within a portable housing 30, one embodiment of which is sized to fit within a vehicle engine compartment. A display device 26 and a user input device 28 are attached adjacent the housing 30 and are accessible to a user of the battery 10. A voltage output connection (Vₒᵤₜ), a charging input connection (Vᵢₙ), and ground connection (G) are also provided on the housing 30. Further description of each of these components is provided hereinafter.

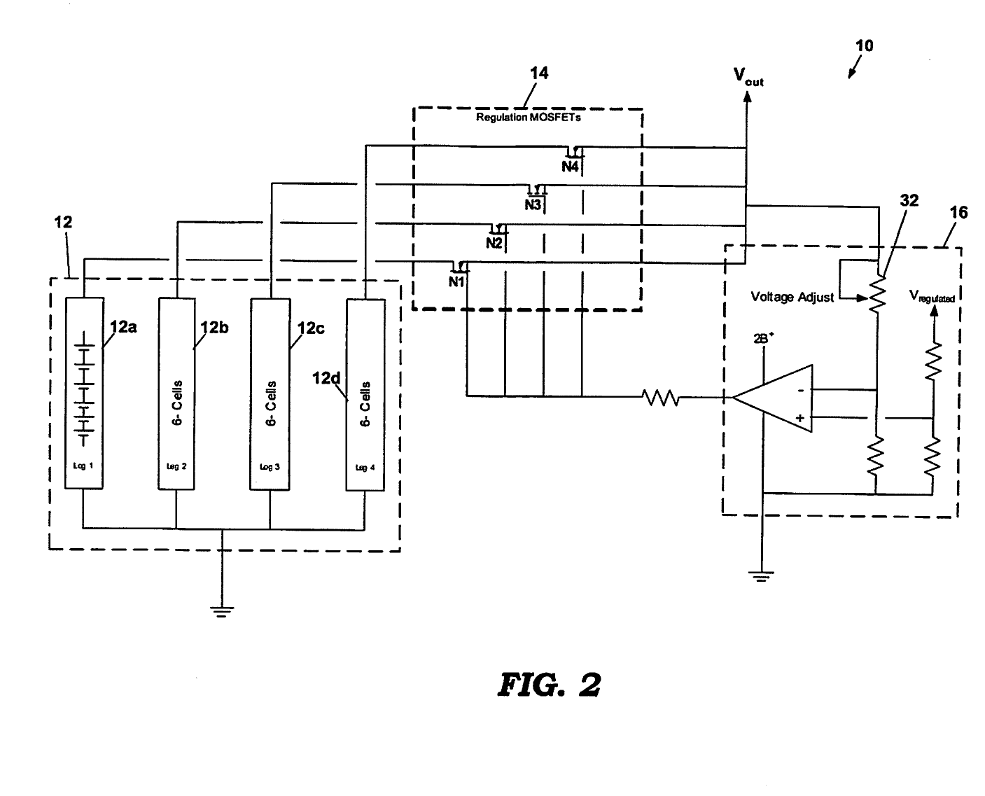

As shown in FIG. 2, the power cells 12 may include multiple legs 12a, 12b, 12c and 12d connected in parallel, with each leg including multiple cells connected in series. For example, each of the legs 12a-12d may include six series-connected 3.2-volt cells which provide a nominal 19.2-volt output voltage for each leg. In one preferred embodiment, the power cells 12 are lithium iron phosphate (LiFePO₄) cells. However, it will be appreciated that the power cells 12 may be lithium ion cells or other type of battery cell. Thus, the disclosure is not limited to any particular type of cell or any particular cell chemistry.

The output voltage of each of the legs 12a-12d is connected to the voltage regulation circuit 14. In a preferred embodiment depicted in FIG. 2, the voltage regulation circuit 14 includes four N-channel enhancement-mode MOSFETs N1, N2, N3 and N4 each having its drain connected to the output voltage of a corresponding one of the legs 12a-12d. As long as the gate-to-source voltage is maintained higher than a threshold voltage (such as using a charge pump or voltage doubler), each MOSFET N1-N4 maintains the voltage at its source (Vₒᵤₜ) at a substantially constant level, which level is determined by the voltage applied to its gate. Although FIG. 2 depicts an embodiment having four legs, it will be appreciated that any number of legs is possible, and the disclosure is not limited to any particular number of legs.

Thus, with the voltage regulation circuit 14 of the preferred embodiment, the output voltage of the legs 12a-12d is preferably higher than the regulated voltage at the output connection (Vₒᵤₜ). This is advantageous because having an available voltage in the cells which is considerably higher than the desired output voltage (Vₒᵤₜ) allows for tighter regulation of the output voltage. In addition, more watt-hours of energy can be stored and used at a lower voltage over a longer time than can be accomplished with a non-regulated battery.

Although a preferred embodiment of the disclosure incorporates a linear voltage regulation technique, it will be appreciated that other types of regulation may be applied, such as, for example, a switching regulation technique or a combination of linear regulation and switching regulation. Thus, the disclosure is not limited to any particular voltage regulation technique.

A voltage adjustment circuit 16 is provided to adjust the level of the voltage on the gates of the MOSFETs N1-N4. In the embodiment of FIG. 2, the voltage adjustment circuit 16 acts as a voltage doubler to provide a gate voltage which is nominally twice the voltage at the battery output (Vₒᵤₜ). The gate voltage, and thus the battery output voltage Vₒᵤₜ, may be set to a particular value using a variable resistor 32, which may be manually controlled or automatically controlled based on a control signal from the microprocessor 24.

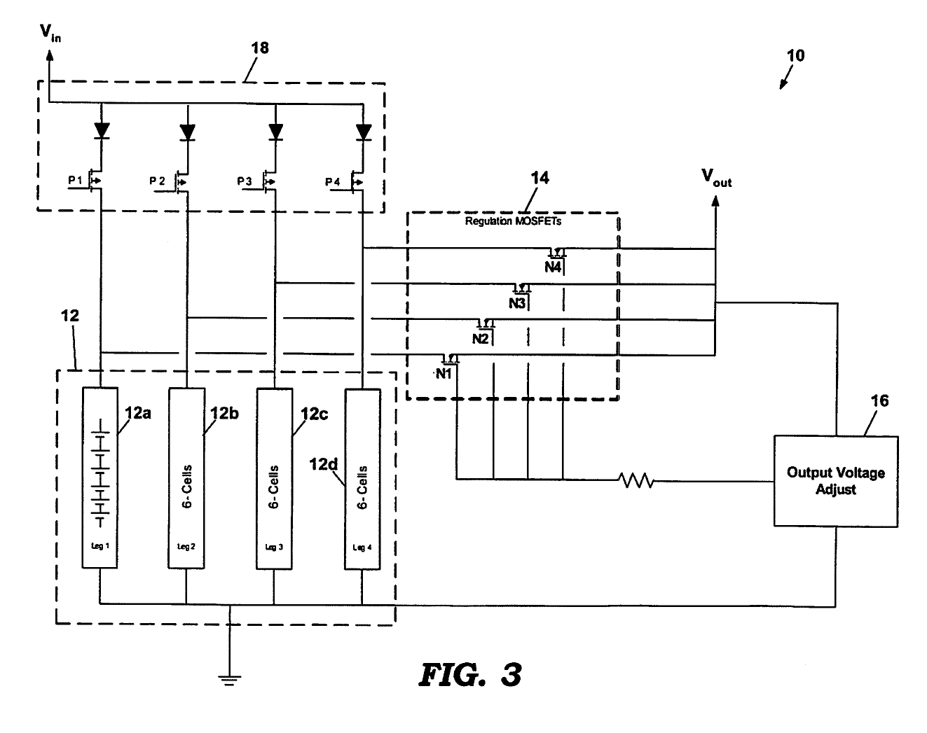

As shown in FIG. 3, the charging circuit 18 includes four P-channel enhancement-mode MOSFET switches P1, P2, P3 and P4 each having its source connected to the output voltage of a corresponding one of the legs 12a-12d. The gate voltages of the switches P1-P4 are controlled by the microprocessor 24. Under normal conditions, the gate voltages are set to cause the switches P1-P4 to be closed (turned ON) to allow charging current to flow from the charging input connection (Vᵢₙ) to each of the legs 12a-12d. If a charging fault is detected in any one of the legs 12a-12d, the corresponding switch P1-P4 is opened based on control of the gate voltage. Charging faults are detected by a polling routine executed by the microprocessor 24 that compares the voltage on each leg 12a-12d to preset thresholds. These thresholds include a minimum voltage, a maximum voltage, and a deviation from an average voltage. For example, the deviation threshold may be 0.5-1.0 volt below the maximum leg voltage. These thresholds, which are preferably set to programmed values away from the average, are considered an indication of a fault.

Conventional vehicle batteries have two connection points: a voltage output which is typically the (+) post, and a ground which is typically the (−) post. Such conventional batteries are charged by applying a charging voltage to the voltage output (+) post. As a result, the charging voltage is generally the same as or only slightly higher than the output voltage. As discussed above, preferred embodiments of the battery 10 provide a charging input connection (Vᵢₙ) that is separate from the voltage output connection (Vₒᵤₜ). This provides the advantage of being able to charge the battery 10 at a voltage which may be significantly higher than the output voltage. This allows for faster recharge than would otherwise be possible. It is also advantageous for voltage regulation, since the input voltage (Vᵢₙ) to the voltage regulation circuit 14 is higher than the maximum output voltage (Vₒᵤₜ) requested. The separate charging input connection also provides protection for the internal components/circuits.

Preferred embodiments of the battery 10 take temperature measurements at several points where individual cells generate the most heat during operation. Temperature measurements are also taken at one or more of the MOSFET heat sinks to confirm they are operating inside of tolerances. If these temperatures reach a predetermined level that may cause damage to the battery components or cause a fire hazard, the micro-processor 24 opens the circuit on the leg wherein the high-temperature measurement was made, taking that leg out of the configuration.

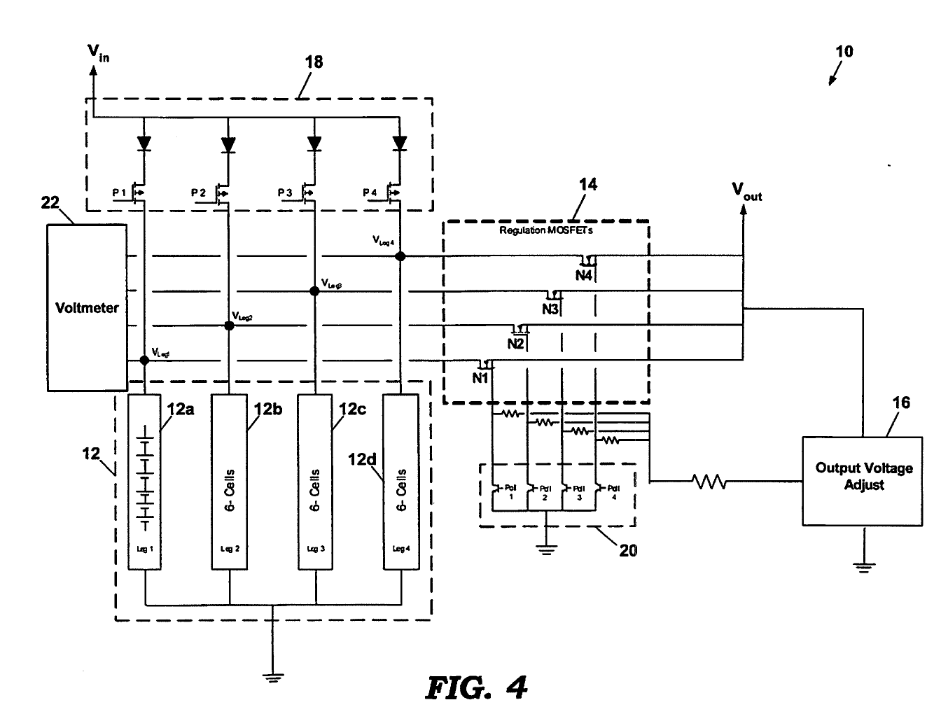

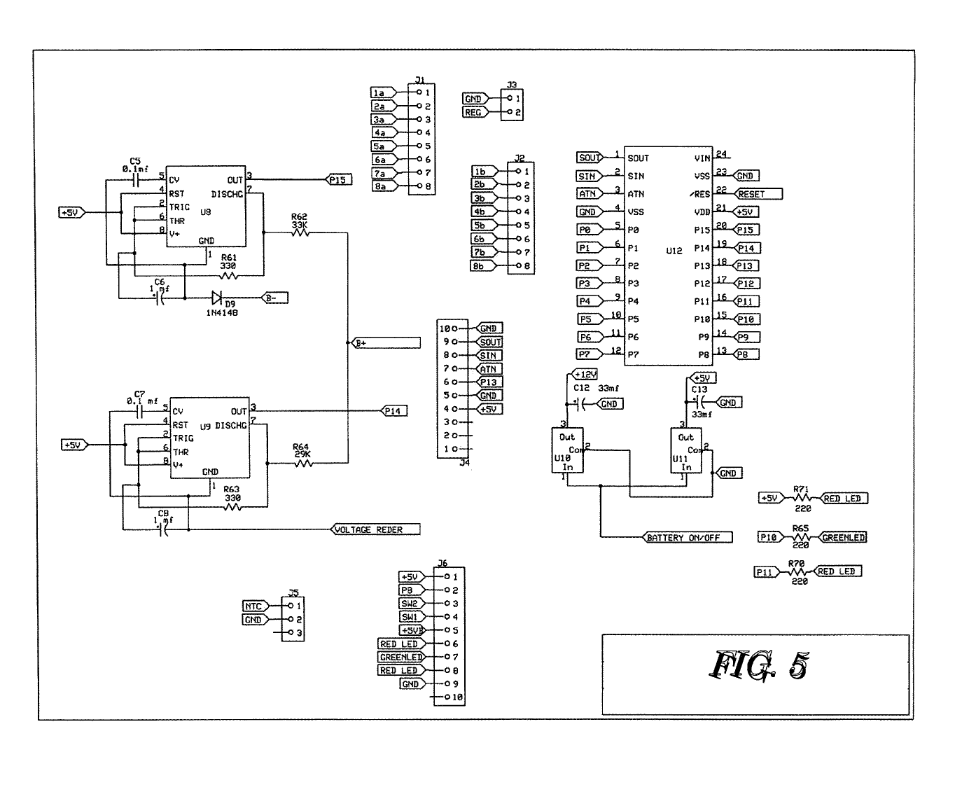

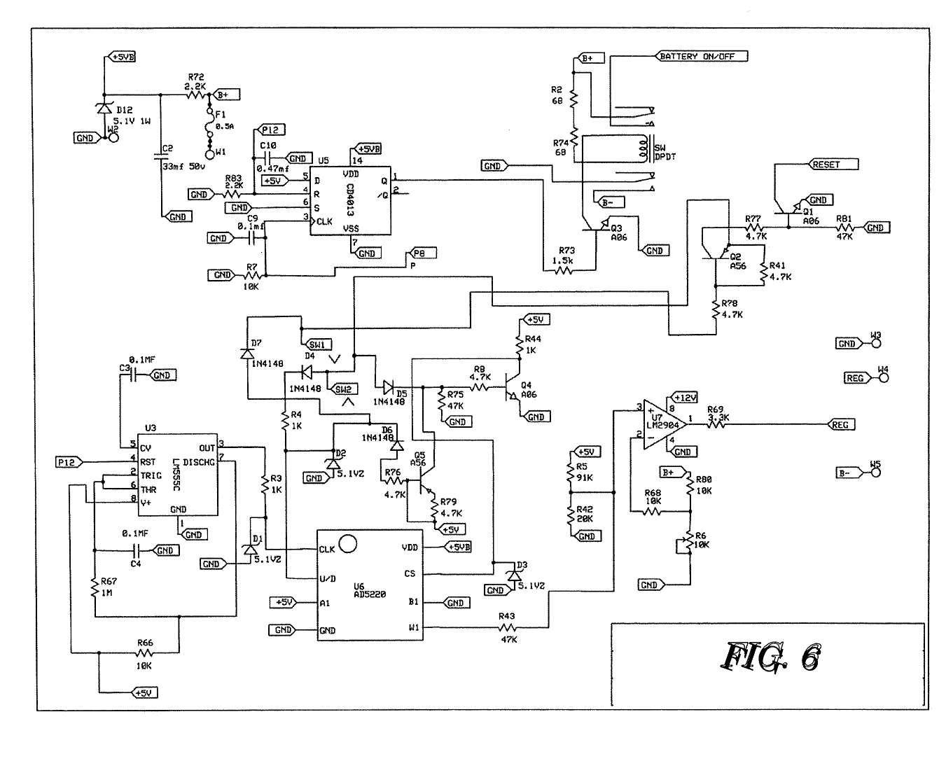

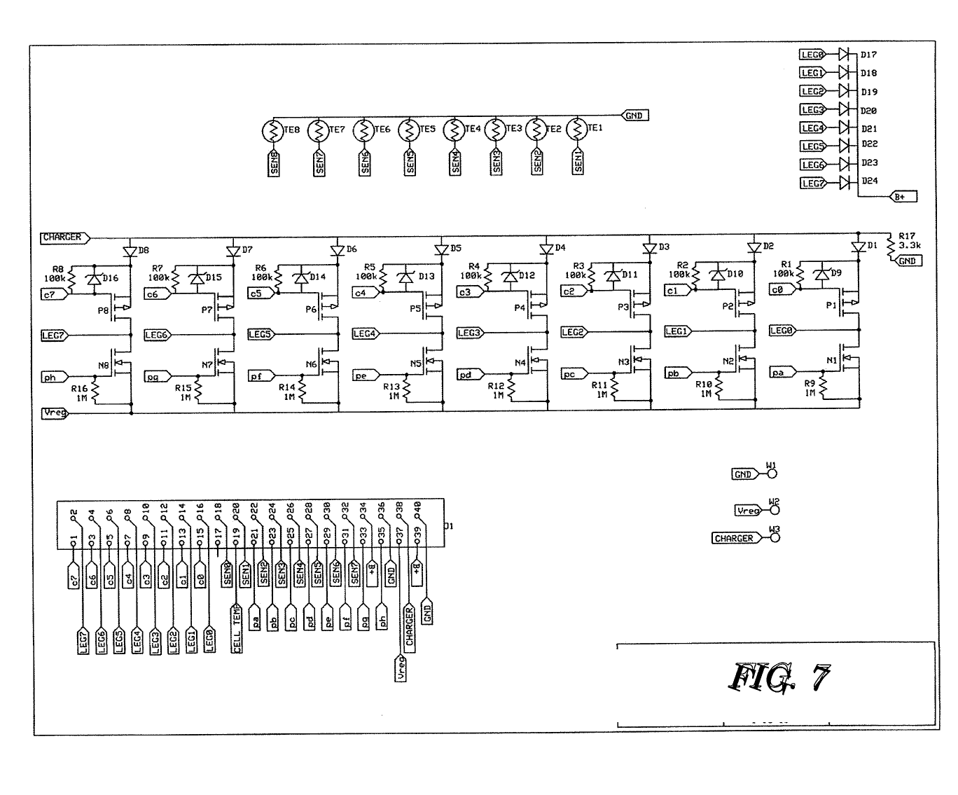

The polling circuit 20 preferably includes polling transistor switches, the number of which corresponds to the number of legs of the power cells 12. In a preferred embodiment depicted in FIG. 4, there are four polling transistor switches Poll₁, Poll₂, Poll₃ and Poll₄ corresponding to the four legs 12a-12d of the power cells 12. The gate voltages of the switches Poll₁-Poll₄ are controlled by the microprocessor 24. When one of the switches Poll₁-Poll₄ is turned on, the gate of the corresponding MOSFET N1-N4 is grounded which turns off (opens) the corresponding MOSFET N1-N4. This effectively disconnects the corresponding leg 12a-12d of the power cells 12 from the output connection (Vₒ) and any load connected thereto. During a polling operation, the switch P1-P4 connected to the polled leg 12a-12d is opened which disconnects the leg 12a-12d from the charging voltage connection (Vᵢ) and prevents charging current from flowing to the disconnected leg. Preferably, the opening of the MOSFET N1-N4 and the opening of the corresponding switch P1-P4 occurs substantially simultaneously, the timing of which is determined by a polling pulse generated under control of the microprocessor 24.

When the polled leg has been disconnected from the voltage output connection and the charging input connection, a voltmeter 22 is triggered to measure the voltage at the output of the polled leg. The triggering of the voltmeter 22 is preferably initiated by the same polling pulse that closes the switch Poll₁-Poll₄ and opens the switch P1-P4. The microprocessor 24 receives the voltage measurement from the voltmeter 22, compares the measurement to a pre-set threshold value (maximum or minimum), and initiates action when the voltage measurement exceeds or falls below the threshold. For example, if the output voltage of leg 12b (which is normally about 12 volts) drops below a preprogrammed threshold voltage, the microprocessor 24 generates a signal to cause the switch Poll₂ to close and the switch P2 to open, thereby isolating the leg 12b from the rest of the legs 12a, 12c and 12d. This prevents the other legs 12a, 12c and 12d from discharging through the faulty leg 12b, which could cause overheating and possibly a fire or explosion. Even with an isolated or “quarantined” leg, the battery 10 can continue to operate, but with a warning light or warning message displayed on the display device 26.

One skilled in the art will appreciate that a potentially faulty leg may be polled multiple times, and/or checked against different threshold levels before the leg is isolated. This may be done to ensure that the leg is not isolated based on an anomalous voltage measurement. Polling can occur, for example, every five to ten seconds or so; most preferably about every seven seconds.

Since each of the switches Poll₁-Poll₄ and P1-P4 can be controlled independently, an individual leg 12a-12d of the power cells 12 can be polled while the other legs 12a-12d continue providing output voltage to a load and/or being charged by an input charging voltage. In this manner, polling can occur continuously without substantially affecting the output voltage of the battery 10. In a preferred embodiment, polling occurs every five minutes while the battery is in operation.

As described in more detail below, the battery 10 may be set to an “OFF” mode using the user input device 28. In the “OFF” mode, all of the switches P1-P4 and N1-N4 are opened to electrically isolate all of the legs 12a-12d of the power cells 12.

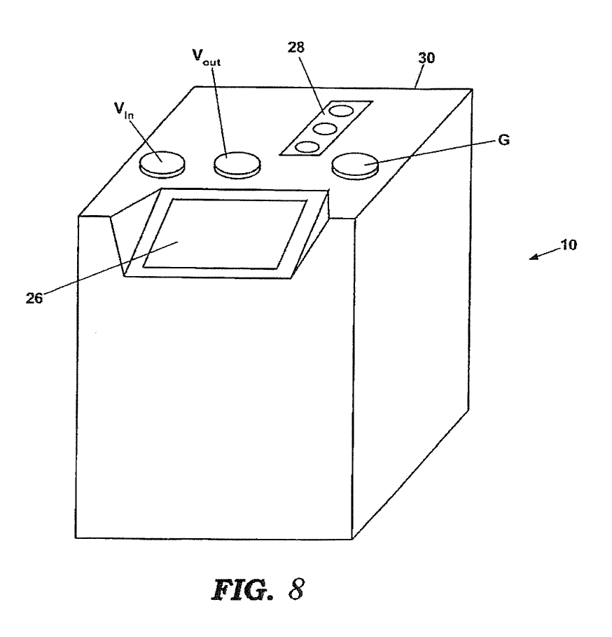

As shown in FIGS. 1 and 8, some embodiments of the battery 10 include a display device 26 coupled to the microprocessor 24 for displaying battery information to a user. In one preferred embodiment, the display device 26 includes, for example, an LCD display panel which may indicate the battery status (ON or OFF) and the regulated voltage level. The display device 26 also indicates the current protection mode (“full” or “partial”) of the battery 10. In the partial protection mode, if any of the legs 12 are found to be out of tolerance, the faulty leg is disconnected by opening the corresponding MOSFET N1-N4 of the voltage regulation circuit 14. In the full protection mode, all of the MOSFETs N1-N4 are opened. Full protection may be initiated due to a fault condition existing simultaneously in all of the legs 12a-12d, such as a low voltage condition due to over-discharge or an outside factor such as over-voltage charging. The display device 26 may also be used to display the set point for the regulated voltage level as a user adjusts that value. In alternative embodiments, the display device 26 comprises one or more light emission devices (e.g., LEDs) for indicating the status of the battery 10.

Some embodiments of the battery 10 also include a user input device 28 coupled to the microprocessor 24 for setting the protection mode, for manually switching the battery 10 between OFF and ON, and for adjusting the regulated voltage level. As shown in FIG. 8, a preferred embodiment of the user input device 28 comprises three momentary push button switches. For example, pressing the “P” switch for some extended period, such as five seconds, activates the voltage setting mode wherein the “up” (↑) and “down” (↓) buttons may be used to increment or decrement the voltage set point in 0.1 volt increments. Pressing the “↑” button for some extended period, such as five seconds, could reset the protection mode. Pressing the “↓” button for some extended period, such as five seconds, could turn the battery ON or OFF, depending on the current state. In some embodiments of the disclosure, the input device 28 includes a remotely-wired switch 34 which may be used to remotely turn the battery ON or OFF.

Preferred embodiments of the battery 10 include a cell balancing function which applies passive resistance balancing. Cell balancing is the process of insuring that all cells of the legs 12 are charged to the same rate of charge acceptance which is estimated by the open circuit voltage. This is accomplished by routing the charging current through a series diode having a negative temperature coefficient of electrical resistance (TCR). As the diode heats up, the diode's forward voltage decreases. Thus, if a leg has a lower voltage, it will draw more current which increases the heat. The increased heat causes a lower forward voltage. Some preferred embodiments also include a passive diode isolation feature that isolates the legs 12a-12d making it impossible to back feed current to an individual series-connected cell block.

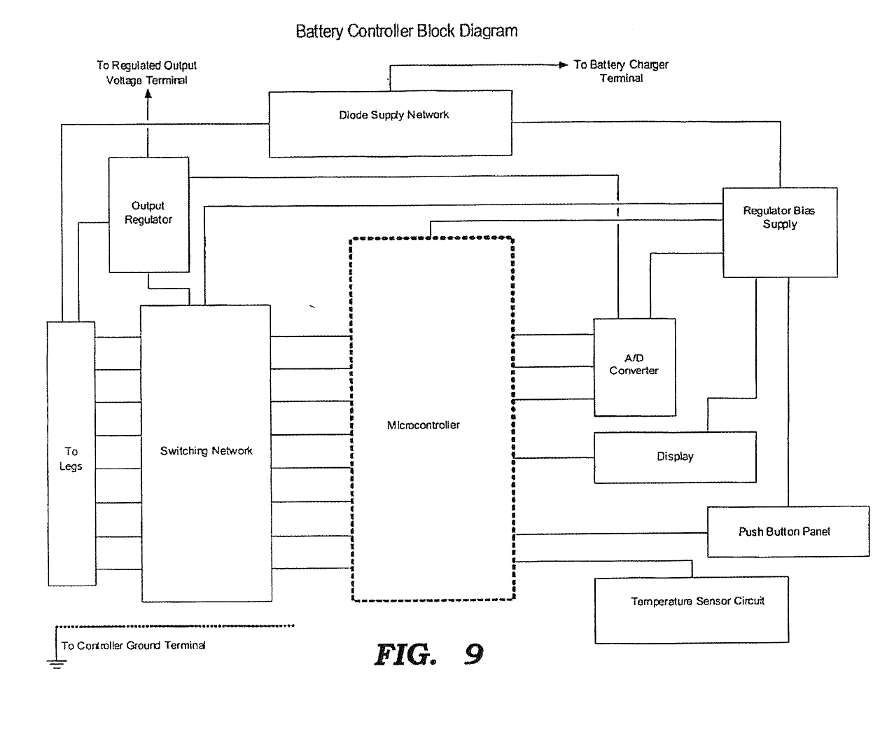

FIG. 9 depicts a block diagram of an alternative embodiment of a system for monitoring and controlling the operation of power cells within a battery.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A portable battery comprising a plurality of power cells, a voltage regulation circuit connected to the plurality of power cells, and an output voltage adjustment circuit connected to the voltage regulation circuit, and a housing for at least partially sheltering at least some of the other parts of the portable battery.

2. The portable battery of claim 1 wherein the plurality of power cells, the voltage regulation circuit, and the output voltage adjustment circuit are each disposed within the housing.

3. The portable battery of claim 1 wherein the plurality of power cells further comprises a plurality of legs connected in parallel wherein each leg includes a plurality of cells connected in series.

4. The portable battery of claim 1 further comprising a user input device to modify an output voltage to a user-selected level.

5. The portable battery of claim 3 further comprising a charging circuit, the charging circuit including a first switching network operable to individually connect or disconnect one or more of the legs to or from a charging input connection.

6. The portable battery of claim 5 wherein the first switching network further comprises control circuitry including a microprocessor.

7. The portable battery of claim 5 further comprising a polling circuit including a second switching network that is operable to individually connect or disconnect each of the legs to or from a voltage output connection and the charging input connection.

8. The portable battery of claim 7 further comprising a voltmeter connected to each of the legs wherein the voltmeter is operable to measure an output voltage on a particular leg during a time period when such leg is disconnected from both the voltage output connection and the charging input connection.

9. The portable battery of claim 8 wherein the first switching circuit and the second switching circuit further comprise control circuitry including a microprocessor.

10. The portable battery of claim 9 wherein the control circuitry monitors the output voltage measured by the voltmeter, and wherein if the output voltage for a particular leg is outside a predefined range, the control circuitry is operable to control the polling circuit to isolate such leg from the voltage output connection and the charging input connection.

11. The portable battery of claim 10 further comprising a plurality of heat sensors connected to the control circuitry and located adjacent or within one or more zones located within the portable battery, wherein the control circuitry monitors the heat sensors to determine whether the one or more zones exhibit a temperature outside the predefined range.

12. The portable battery of claim 11 wherein a first heat sensor is located adjacent a first leg for sensing the temperature of a first zone, a second heat sensor is located adjacent a second leg for sensing the temperature of a second zone, and an N^{th} heat sensor is located adjacent an N^{th} leg for sensing the temperature of an N^{th} zone, wherein the control circuitry is operable to disable one or more legs in the event the sensed temperature or temperatures for the one or more legs is outside the predefined range.

13. The portable battery of claim 9 further comprising a display device connected to the microprocessor for displaying information indicating the status of the portable battery or one or more sub-parts of the portable battery.

14. The portable battery of claim 9 wherein the control circuitry periodically takes reference measurements of the open circuit voltage of each leg.

15. The portable battery of claim 14 wherein the control circuitry compares the reference measurements of the open circuit voltage of each leg to determine whether the open circuit voltage of one or more legs is outside a predefined voltage range, and to transmit a deviation signal identifying the one or more deviating legs to a feedback system.

16. The portable battery of claim 15 wherein the feedback system comprises a feedback apparatus selected from the group consisting of an indicator light, a display screen, and automated cutoff circuitry.

17. The portable battery of claim 16 wherein the cutoff circuitry comprises a circuit configured for automatically disabling one or more legs in response to a deviation signal identifying one or more legs having an output voltage that is outside the predefined voltage range.

18. A method of maintaining optimal performance for a portable battery including a plurality of legs connected in parallel, the method comprising the steps of:
a. receiving one or more sensor signals from one or more sensors associated with one or more of the legs, wherein the sensor signals are indicative of a characteristic of one or more the legs;
b. determining based on the sensor signals whether the sensed characteristic is outside a predefined range;
c. disabling a leg if it is determined that the characteristic sensed for that leg is outside the predefined range.

19. The method of claim 18 wherein the characteristic is temperature.

20. The method of claim 18 wherein the characteristic is open circuit voltage.
